(19) United States
(12) Patent Application Publication
(10) Pub. No.: US 2010/0060863 A1
(43) Pub. Date: Mar. 11, 2010

(54) Distortion Altering Optics for MEMS Scanning Display Systems or the Like

(75) Inventors: Joshua M. Hudman, Redmond, WA (US); Joshua O. Miller, Woodinville, WA (US)

Correspondence Address: MICROVISION, INC., 6222 185TH AVENUE NE, REDMOND, WA, 98052, US

(73) Assignee: MICROVISION, INC., Redmond, WA (US)

(21) Appl. No.: 12/208,550

(22) Filed: Sep. 11, 2008

(51) Int. Cl. G03B 21/14

(52) U.S. Cl. 353/70

(57) ABSTRACT

Briefly, in accordance with one or more embodiments, a wedge is disposed after the MEMS scanner in a MEMS scanning display system which redirects the scan cone at the same time stretches and/or squashes the image to reduce or eliminate distortion inherent in scanning projectors, the distortion being a result of a trajectory of the scanned beam caused by the off axis input beam and a transform from a scanning mirror to an image plane.

### BACKGROUND

Microelectromechanical system (MEMS) scanning display systems typically may have naturally occurring distortion as a result of the feed method used and also because a MEMS scanning mirror is used to convert an image created in a polar coordinate system into an image using a Cartesian coordinate system at the image plane, the distortion being a result of a trajectory of the scanned beam caused by the off axis input beam and a transform from a scanning mirror to an image plane. Unlike standard optical systems a lens generally cannot be placed after the MEMS scanning mirror because such an arrangement would prevent the scanning system from having infinite focus.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a diagram of a MEMS based scanned beam display in accordance with one or more embodiments;

FIG. 2 is an elevation view of a wedge optic in accordance with one or more embodiments;

FIG. 3 is a top plan view of a wedge optic in accordance with one or more embodiments;

FIG. 4 is a diagram of scanned beam display showing relative angles of the elements of the display with respect to beam angle in accordance with one or more embodiments;

FIG. 5 is an isometric view of a scanned beam display utilizing a wedge optic in accordance with one or more embodiments;

FIG. 6 is an elevation view of a scanned beam display utilizing a wedge optic in accordance with one or more embodiments;

FIG. 7 is a top plan view of a scanned beam display utilizing a wedge optic in accordance with one or more embodiments; and

FIG. 8 is a diagram illustrating alteration of image distortion via a wedge optic in accordance with one or more embodiments will be discussed.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

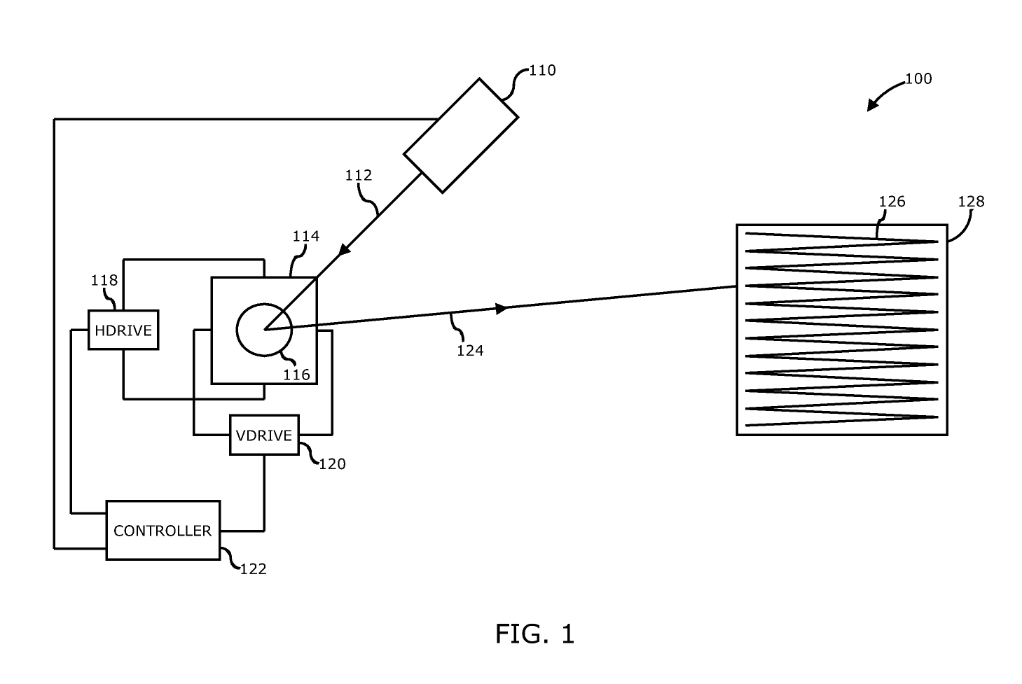

Referring now to FIG. 1, a diagram of a microelectromechanical system (MEMS) based scanned beam display in accordance with one or more embodiments will be discussed. Although FIG. 1 illustrates a scanned beam display system for purposes of discussion, it should be noted that a scanned beam imaging system, other types of imaging systems may be utilized in one or embodiments, and/or alternatively imaging systems such as a bar code scanner or digital camera could likewise be utilized in accordance with one or more embodiments, and the scope of the claimed subject matter is not limited in this respect. As shown in FIG. 1, scanned beam display 100 comprises a light source 110, which may be a laser light source such as a laser or the like, capable of emitting a beam 112 which may comprise a laser beam. In some embodiments, light source may comprise two or more light sources, such as in a color system having red, green, and blue light sources, wherein the beams from the light sources may be combined into a single beam. The beam 112 impinges on a scanning platform 114 which may comprise a microelectromechanical system (MEMS) based scanner or the like, and reflects off of scanning mirror 116 to generate a controlled output beam 124. In one or more alternative embodiments, scanning platform 114 may comprise a diffractive optic grating, a moving optic grating, a light valve, a rotating mirror, a spinning silicon device, a flying spot projector, or other similar scanning devices or moving light projecting devices, and the scope of the claimed subject matter is not limited in this respect. A horizontal drive circuit 118 and/or a vertical drive circuit 120 modulate the direction in which scanning mirror 116 is deflected to cause output beam 124 to generate a scanned beam 126, thereby creating a displayed image 128, for example on a projection surface and/or image plane. Although scanned beam 126 may comprise a raster scan as shown in FIG. 1 as an example in one particular embodiment, the projected image need not be limited to a raster scan wherein other scanned beam patterns may likewise be utilized, and the scope of the claimed subject matter is not limited in this respect. In general, any scanned beam image may be generated. A display controller 122 controls horizontal drive circuit 118 and vertical drive circuit 120 by converting pixel information of the displayed image into laser modulation synchronous to the scanning platform 114 to write the image information as displayed image 128 based upon the position of the output beam 124 in scanned beam 126 and/or any scanned beam pattern, and the corresponding intensity and/or color information at the corresponding pixel in the image. Display controller 122 may also control other various functions of scanned beam display 100.

In one or more embodiments, for two dimensional scanning to generate or capture a two dimensional image, a fast scan axis may refer to the horizontal direction of scanned beam 126 and the slow scan axis may refer to the vertical direction of scanned beam 126. Scanning mirror 116 may sweep the output beam 124 horizontally at a relatively higher frequency and also vertically at a relatively lower frequency. The result is a scanned trajectory of laser beam 124 to result in scanned beam 126, and/or generally any scanned beam pattern. However, the scope of the claimed subject matter is not limited in these respects.

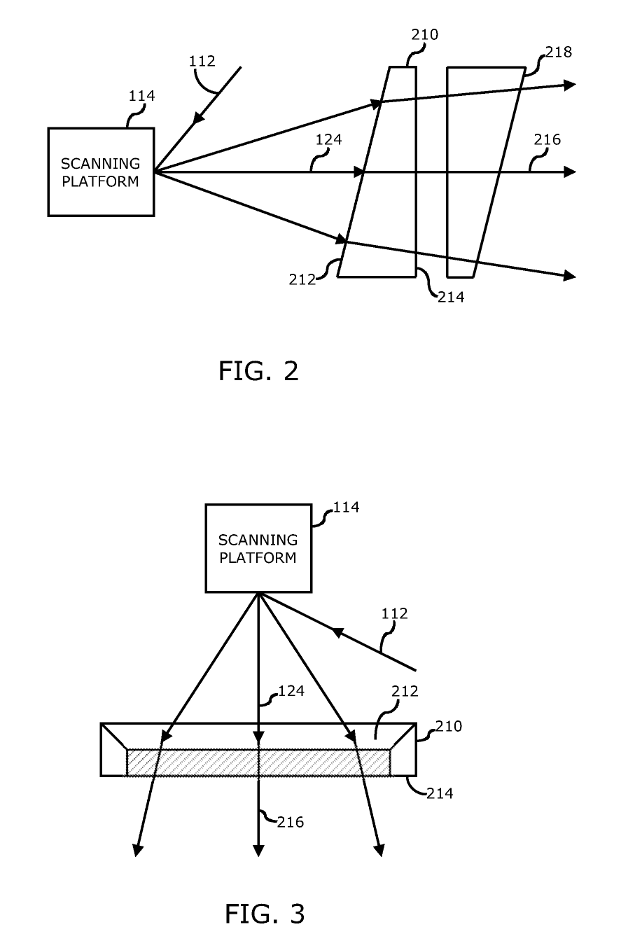

Referring now to FIG. 2 and FIG. 3, an elevation view and a top plan view, respectively, of a wedge optic in accordance with one or more embodiments will be discussed. In one or more embodiments, a wedge optic 210 may be utilized to alter the image generated by scanned beam display 100 as shown in FIG. 1. In one or more embodiments, wedge optic 210 may be utilized to reduce or eliminate distortion in an image generated by a scanning platform 114 that may result inherently in scanned beam display or imaging systems, the distortion being a result of a trajectory of the scanned beam caused by the off axis input beam and a transform from a scanning mirror to an image plane. Alternatively, wedge optic 210 may be utilized to impart or increase an amount of distortion in an image generated by scanning platform 114, for example where such increased or otherwise imparted distortion is desirable according to the application. In general, wedge optic 210 may be utilized to provide some alteration of distortion of the image generated or obtained by scanning platform 114. In one or more embodiments, wedge optic 210 generally may comprise an optical element, or a combination of optical elements, having a first surface or plane 212 disposed at a non-parallel angle with respect to a second surface or plane 214. In one or more embodiments, such an arrangement of wedge optic 210 may comprise a prism or similarly shaped optic such as a frustum, pyramid, cone or the like, and/or alternatively wedge optic 210 may comprise a first pane of glass or other optical material to embody first surface 212 and a second pane of glass or other optical material to embody second surface 214, and the scope of the claimed subject matter is not limited in these respects.

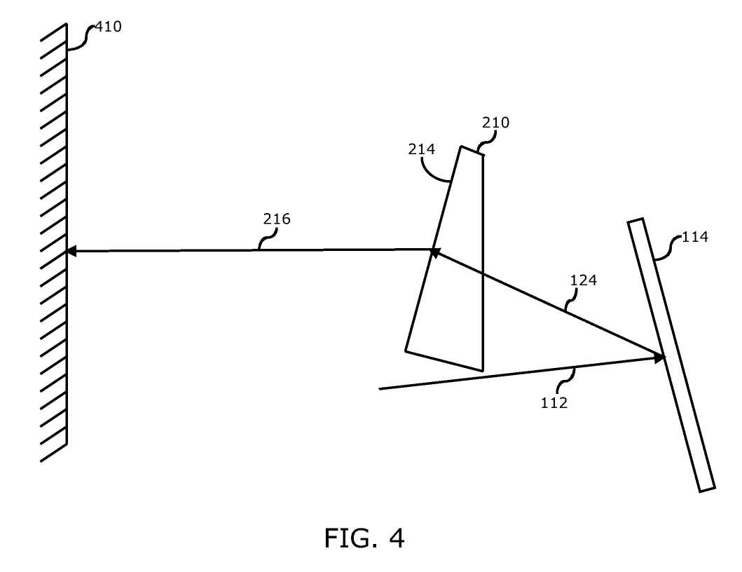

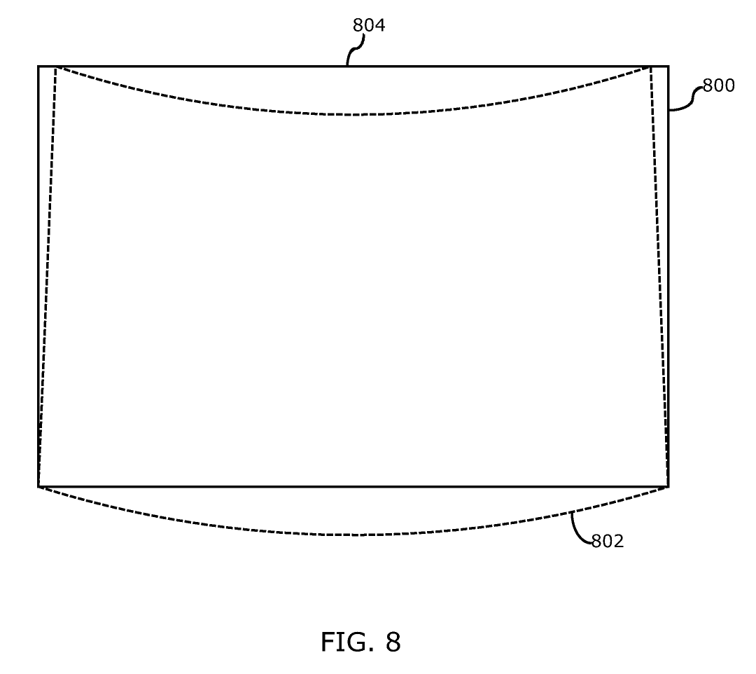

As shown in FIG. 2 and FIG. 3, output beam 124 reflected and/or generated by scanning platform 114 may be directed to pass through wedge optic 210 which in turn redirects the rays of output 124 at least in part in order to control exit beam 216 exiting from wedge optic 210. In such an arrangement, wedge optic 210 is capable of altering distortion of the image generated and/or scanned by scanning platform 114. In one embodiments, wedge optic 210 is capable of altering distortion of an image in at least one dimension, and in one or more alternative embodiments wedge optic is capable of altering distortion of an image in two or more dimensions and/or along two or more axes. An example of such distortion alteration is shown in and described with respect to FIG. 8, below. In one or more embodiments, the angle at which first surface 212 of wedge optic 210 is disposed with respect to second surface 214 of wedge optic 210 may be based at least in part on the feed angle of input beam 112 which is scanned or otherwise redirected by scanning platform 114. Furthermore, as illustrated in FIG. 4, below, wedge optic 210 may be disposed at angle with respect to a reflection surface or scanning plane of scanning platform 114, depending on, for example, the arrangement of the elements of display system 100. Although wedge optic 210 is shown in FIG. 2 and FIG. 3 as being disposed in the light path after input beam 112 is fed to scanning platform 114, in one or more alternative embodiments, wedge optic 210 may be disposed in the light path before input beam 112 is fed to scanning platform 114. In one or more embodiments, wedge optic 210 may be disposed at least in part before input beam 112 is fed to scanning platform 114, and/or at least in part after input beam 112 is fed to scanning platform 114, for example where first surface 212 is disposed in the light path before input beam 112 reaches scanning platform 114, and where second surface 213 is disposed in the light path after input beam reaches scanning platform 114. However, these are merely examples of where wedge optic 210 may be disposed, and the scope of the claimed subject matter is not limited in these respects.

In one or more embodiments as shown in FIG. 2, a second wedge optic 218 may be utilized in addition to and in combination with wedge optic 210. Utilizing two or more wedge optics in combination may provide further optimization of the projected image. For example, the first wedge optic 210 may provide most or substantially all of the distortion correction in the projected image. However, in multichromatic projectors such as red-green-blue (RGB) projectors, such distortion correction and/or adjustment may also introduce chromatic aberration along the axis on which distortion is corrected and/or adjusted, which may be for example the Y-axis for correction of smile distortion as shown in and described with respect to FIG. 8, below. In such embodiments, second wedge optic 218 may be utilized to correct and/or otherwise adjust this chromatic aberration introduced by the first wedge optic 210. In one or more embodiments, the chromatic aberration introduced by the first wedge optic 210 may be at least partially or wholly corrected and/or adjusted electronically via pixel-by-pixel adjustment of the projected image, alone or in combination with at least partial correction and/or adjustment of chromatic aberration via second wedge optic 218. In embodiments where second wedge optic 218 is utilized to correct and/or adjust chromatic aberration introduced by the first wedge optic 210, second wedge optic 218 may comprise an inverse wedge having a different index of refraction than the first wedge optic 210. Such a second wedge optic 218 also may have a different wedge angle than the wedge angle of the first wedge optic 210. The wedge angle of the second optic 218 may be adjusted with respect to the wedge angle of the first wedge optic 210, or vice versa, to optimize the resulting distortion correction and/or adjustment with respect to the correction and/or adjustment of chromatic aberration. In general, second wedge optic 218 may have opposite, or effectively opposite, optical properties compared to the optical properties of first wedge optic 210, and may comprise, for example, crown and flint glass designed to have such optical properties, such as having a lower index of refraction and/or a higher Abbe number compared to the first wedge optic 210. Alternatively, the second wedge optic 218 may comprise the same or nearly the same type of glass or optical material as first wedge optic 210, and the first wedge optic 210 may be designed to over correct and/or over adjust the image distortion, and then the second wedge optic 218 may be designed to correct and/or adjust back the distortion by a lesser amount, for example by having a smaller wedge angle than the wedge angle of first optic 210, to reach a desired amount of overall distortion correction and/or adjustment in the combination of first wedge optic 210 and second wedge optic 218, while also having the same, or nearly the same amount of chromatic aberration in equal or nearly equal but opposite directions. In general, the amount of optical distortion correction and/or adjustment may be controlled via the wedge angles, and the chromatic aberration correction and/or adjustment may be controlled via wedge material properties such as index of refraction, and the scope of the claimed subject matter is not limited in this respect. In addition, in one or more embodiments, one or both of first wedge optic 210 and/or second wedge optic 218 may be substituted with other optical elements having similar distortion correction and/or adjustment properties and/or chromatic aberration correction and/or adjustment properties. For example, wedge optic 210 and/or wedge optic 218 may alternatively comprise a distortion grating or a gradient-index GRIN optic, or other similar optical elements, and the scope of the claimed subject matter is not limited in this respect.

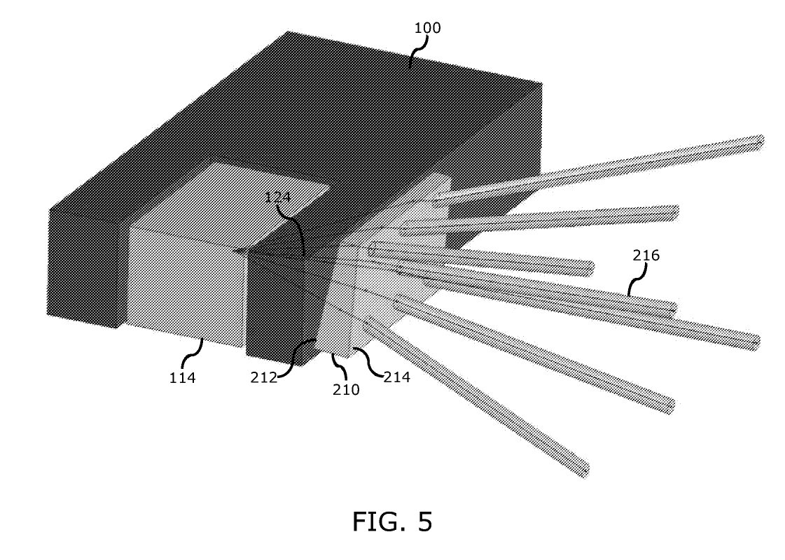

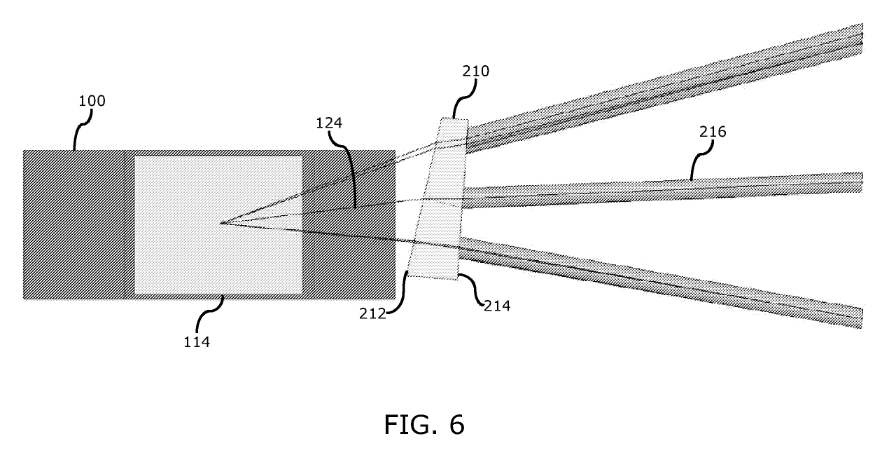

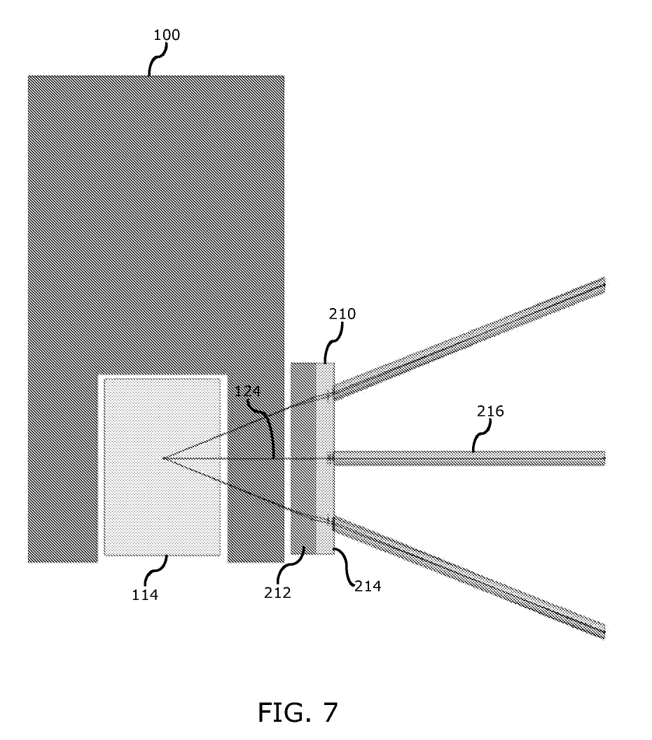

Referring now to FIG. 4, a diagram of scanned beam display showing relative angles of the elements of the display with respect to beam angle in accordance with one or more embodiments will be discussed. As shown in FIG. 4, scanning platform 114 may receive a beam 112 to be scanned at a feed angle that is not perpendicular to the surface of reflection or the scanning plane of scanning platform 114. In other words, the feed angle of beam 112 may be disposed “off axis” with respect to a line normal to the scanning plane of scanning platform 112. Furthermore, scanning platform 112 itself may be disposed at an angle with respect to a horizontal reference plane and/or with respect to a line normal to a horizontal reference plane, or a vertical plane of reference. Likewise, wedge optic 210 may be disposed at an angle with respect to a horizontal reference plane and/or with respect to a line normal to a horizontal reference plane, or a vertical plane of reference. In one or more embodiments, beam 112 to be scanned may be disposed at feed angle of about 12.5 degrees off axis from a scanning surface of scanning platform 114, the scanning platform 114 may be disposed at a tilt angle of about 4 degrees from a horizontal reference plane, and first surface 212 of wedge optic 210 may be disposed generally normal to the horizontal reference plane wherein first surface 212 of wedge optic 210 is disposed at about 8.5 degrees with respect to second surface 214 of wedge optic 210. In general, the wedge angle of wedge optic 210, namely the angle between surface 212 and surface 214, is at least in part a function of the feed angle of the input beam 112 applied to scanning platform 114. Alternatively, second surface 214 of wedge optic 210 may be disposed generally normal to the horizontal reference plane. In such an arrangement, when output beam 216 is scanned across an image surface 410 or image plane, the image may have about 13% distortion without utilization of wedge optic 210, and may have about 5% distortion when wedge optic 210 is utilized. Thus, in such an arrangement, in one or more embodiments, wedge optic 210 may be utilized to reduce image distortion in a scanned beam display, although the scope of the claimed subject matter is not limited in these respects. An example of a scanned beam display utilizing wedge optic 210 to alter image distortion is shown in an described with respect to FIG. 5, FIG. 6, and FIG. 7, below.

Referring now to FIG. 5, FIG. 6, and FIG. 7, an isometric view, an elevation view, and a top plan view, respectively, of a scanned beam display utilizing a wedge optic in accordance with one or more embodiments will be discussed. FIG. 5, FIG. 6, and FIG. 7 illustrate how scanned beam display 100 of FIG. 1 may be tangibly embodied in a single module that may be utilized in smaller form factor devices such as cellular telephones, music and/or video players, mobile computers, personal digital assistants, and so on. In such an arrangement of scanned beam display 100, scanning platform 114 may be arranged within the module of scanned beam display 100, wherein the output beam 124 exiting scanning platform 114 may pass through wedge optic 210 to result in alteration of the path or paths of exit beam 216 exiting scanned beam display 100 which results in alteration of distortion of the resulting projected image. In one or more alternative embodiments, where scanned beam display 100 comprises an imaging unit, the direction of the light rays may be reversed such that rays of light beam 216 entering wedge optic 210 may be altered in direction to alter distortion of the image captured via scanning platform 114. In such an imaging unit embodiment, for example where scanned beam display comprises a bar code reader or camera, light source 110 of FIG. 1 may be comprise a light detector or imaging array, although the scope of the claimed subject matter is not limited in these respects. Thus, in one or more embodiments, wedge optic 210 may be capable of altering and/or reducing or correcting distortion in a displayed or captured image. An example where wedge optic 210 is capable of reducing or eliminating keystone distortion or smile distortion in a scanned beam display is discussed with respect to FIG. 8, below.

Referring now to FIG. 8, a diagram illustrating alteration of image distortion via a wedge optic 27 in accordance with one or more embodiments will be discussed. As shown in FIG. 8, image 800 may be displayed by scanned beam display 100 as shown for example in FIG. 1. Image 800 may have image distortion resulting from feeding the beam off axis to scanning platform 114, the distortion being a result of a trajectory of the scanned beam caused by the off axis input beam and a transform from a scanning mirror to an image plane. Such image distortion due to off axis beam feeding may result in a non-square layout 802 of image 800, also referred to as keystone or smile distortion. Such image distortion may be analogized to the change in a rectilinear image projected onto a spherical surface when image 800 is actually projected onto a flat surface. Smile distortion may also be referred to as remapping distortion resulting of the remapping of the image data from polar coordinates into rectilinear or Cartesian coordinates wherein the remapping distortion is a function of the angle at which the input beam 112 is fed off axis from scanning platform 114. In one or more embodiments, wedge optic 210 is capable of correcting such image distortion when scanning platform 114 is fed off axis by input beam 112 to result in a generally square, rectilinear layout 804 of image 800 via the generally wedge shaped arrangement of surface 212 with respect to surface 214 of wedge optic 210 as discussed, above. In one or more embodiments, an example of such smile distortion as shown in FIG. 8 may represent about 13% distortion of image 800 when wedge optic 210 is not used. By using wedge optic 210 in scanned beam display 100, the distortion may be reduced to about 5% or lower, although the scope of the claimed subject matter is not limited in this respect.

Although the claimed subject matter has been described with a certain degree of particularity, it should be recognized that elements thereof may be altered by persons skilled in the art without departing from the spirit and/or scope of claimed subject matter. It is believed that the subject matter pertaining to a distortion altering wedge optic for a MEMS scanning display systems or the like and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. An apparatus, comprising:
a scanning platform capable of scanning an input beam fed off axis to the scanning platform to provide a scanned beam output to display a projected image; and
a optic element capable of altering distortion of the projected image along at least one or more axes, the distortion being a result of a trajectory of the scanned beam caused by the off axis input beam and a transform from a scanning mirror to an image plane.

2. An apparatus as claimed in claim 1, wherein the optic element capable of altering distortion of the projected image comprises a distortion grating, a GRIN optic, or a wedge optic, or combinations thereof, the wedge optic comprising a prism, a cone, a pyramid, a frustum, or one or more surfaces of optical material, or combinations thereof, the wedge optic comprising a first surface and a second surface disposed at a non-parallel angle with respect to the first surface.

3. An apparatus as claimed in claim 1, wherein the optic element capable of altering distortion of the projected image comprises two or more optic elements in combination.

4. An apparatus as claimed in claim 2, wherein the non-parallel angle of the first surface with respect to the second surface is selected as a function of the angle at which the input beam is fed off axis to the scanning platform.

5. An apparatus as claimed in claim 1, wherein the scanning platform comprises a microelectromechanical system (MEMS) scanner, a diffractive optic grating, a moving optic grating, a light valve, a rotating mirror, a spinning silicon device, or a flying spot projector, or combinations thereof.

6. An apparatus as claimed in claim 1, wherein the optic element capable of altering distortion of the projected image is capable of reducing or eliminating smile distortion or keystone distortion, or combinations thereof, in the projected image.

7. An apparatus as claimed in claim 1, wherein the optic element capable of altering distortion of the projected image is capable of increasing distortion, decreasing distortion, correcting distortion, or eliminating distortion, or combinations thereof, in the projected image.

8. An apparatus as claimed in claim 2, wherein the input beam is fed about 12.5 degrees off axis from the scanning platform, the non-parallel angle of the first surface with respect to the second surface is about 8.5 degrees, and the scanning platform is disposed at an angle of about 4 degrees with respect to a horizontal reference plane.

9. An apparatus as claimed in claim 1, wherein the optic element capable of altering distortion of the projected image is disposed entirely before the input beam is fed to the scanning platform, or at least in part before the input beam is fed to the scanning platform, or is disposed entirely after the input beam is fed to the scanning platform, or at least in part after the input beam is fed to the scanning element, or combinations thereof.

10. A scanned beam display, comprising:
a light source capable of generating a light beam as an input beam for scanning;
a scanning platform capable of scanning an input beam fed off axis to the scanning platform to provide a scanned beam output to display a projected image;
a display controller to control the scanning platform and the light source to generate the projected image in response to scanning action of the scanning platform and modulation of the light source; and
a wedge optic capable of altering distortion of the projected image, the distortion being a result of a trajectory of the scanned beam caused by the off axis input beam and a transform from a scanning mirror to an image plane, the wedge optic comprising a first surface and a second surface disposed at a non-parallel angle with respect to the first surface.

11. A scanned beam display as claimed in claim 10, wherein the wedge optic comprises a prism, a cone, a pyramid, a frustum, or one or more surfaces of optical material, or combinations thereof.

12. A scanned beam display as claimed in claim 10, wherein the wedge optic comprises two or more optic elements in combination.

13. A scanned beam display as claimed in claim 10, wherein the non-parallel angle of the first surface with respect to the second surface is selected as a function of the angle at which the input beam is fed off axis to the scanning platform.

14. A scanned beam display as claimed in claim 10, wherein the scanning platform comprises a microelectromechanical system (MEMS) scanner, a diffractive optic grating, a moving optic grating, a light valve, a rotating mirror, a spinning silicon device, or a flying spot projector, or combinations thereof.

15. A scanned beam display as claimed in claim 10, wherein wedge optic is capable of reducing or eliminating smile distortion or keystone distortion, or combinations thereof, in the projected image.

16. A scanned beam display as claimed in claim 10, wherein the wedge optic is capable of increasing distortion, decreasing distortion, correcting distortion, or eliminating distortion, or combinations thereof, in the projected image.

17. A scanned beam display as claimed in claim 10, wherein the input beam is fed about 12.5 degrees off axis from the scanning platform, the non-parallel angle of the first surface with respect to the second surface is about 8.5 degrees, and the scanning platform is disposed at an angle of about 4 degrees with respect to a horizontal reference plane.

18. A scanned beam display as claimed in claim 10, wherein the wedge optic is disposed entirely before the input beam is fed to the scanning platform, or at least in part before the input beam is fed to the scanning platform, or is disposed entirely after the input beam is fed to the scanning platform, or at least in part after the input beam is fed to the scanning element, or combinations thereof.

19. A method to alter remapping distortion in a scanned beam display, the method comprising:
feeding an input beam to be scanned off axis to a scanning platform to generate an output beam in a scan pattern representing a projected image; and
redirecting the input beam, or the output beam, or combinations thereof, using a wedge optic to alter remapping distortion of the projected image, the distortion being a result of a trajectory of the scanned beam caused by the off axis input beam and a transform from a scanning mirror to an image plane.

20. A method as claimed in claim 19, said redirecting comprising redirecting the input beam at entirely before the input beam is fed to the scanning platform, or at least in part before the input beam is fed to the scanning platform, or redirecting the output beam entirely after the input beam is fed to the scanning platform, or at least in part after the input beam is fed to the scanning platform, or combinations thereof.
